(19) United States
(12) Patent Application Publication
(10) Pub. No.: US 2025/0349269 A1
(43) Pub. Date: Nov. 13, 2025

(54) BACKLIGHT EXTRACTION AND CONTROL FOR LOCAL DIMMING DISPLAY

(71) Applicant: Faurecia IRYStec, Inc., Montreal (CA)

(72) Inventors: Hanwook CHUNG, Montreal (CA); Hyunjin YOO, Nepean (CA); Nizar TARABAY, Montreal (CA); Alexandre OKON, Montreal (CA); Jean LORCHAT, Montreal (CA)

(21) Appl. No.: 18/660,960

(22) Filed: May 10, 2024

(51) Int. Cl. G09G 3/34

(52) U.S. Cl. CPC G09G 3/3426; G09G 2320/0626; G09G 2320/0686; G09G 2330/021

(57) ABSTRACT

Herein, there are provided backlight extraction techniques used for local dimming displays, including techniques for training a backlight extraction model and controlling a local dimming display based on backlight extraction values generated by a trained backlight extraction model. The backlight extraction model is characterizable by its use of separate power regularizations for different local dimming regions, particularly where the local dimming regions are each defined, for a given image to be displayed, as the areas of the given image corresponding to luminance characteristics being below or above a threshold amount for the given image. According to aspects herein, the threshold amount for the given image is determined based on projected backlight extraction values so as to obtain a dark local dimming region and a bright local dimming region, each of which has a different power regularization value applied thereto during a process for controlling backlights of the local dimming display.

### TECHNICAL FIELD

This invention relates to methods and systems for determining backlight control for a local dimming display, such as a local dimming liquid crystal display (LCD) used for displaying images or graphics through use of two or more independently-controllable (local) backlights configured to luminate two or more corresponding local dimming regions of the local dimming display.

### BACKGROUND

General liquid-crystal displays (LCDs) are widely used panels for displaying content, videos, images, text, graphics, etc. However, the main limitations are the light leakage and lower contrast ratio (CR) compared to the organic light-emitting diode (OLED) displays. Additionally, such displays are less efficient in terms of power consumption of the backlight units. To overcome these issues, local dimming techniques have been introduced and widely adopted in the LCDs. Such approaches control the backlight unit levels independently and, hence, can reduce power consumption while providing a reasonable CR.

Numerous backlight extraction (BLE) algorithms have been proposed in the past. Some representative methods are based on maximum and average luminance values of given image segments, using an average luminance correction term by considering the local difference between the maximum and average luminance, or considering the pixel distribution of an image using multiple histograms, to name a few. Despite the successful implementation of the local dimming techniques in the LCDs, there are yet remaining challenges such as handling the halo effect, color distortion, clipping artifacts, and the trade-off between the power consumption of the backlight units and displayed image quality.

In recent years, deep neural network (DNN)-based algorithms with strong nonlinear modeling capabilities have found diverse applications, showing remarkable performance. Regarding the local dimming display techniques, a controllable backlight dimming method has been introduced, where it had been proposed to use a user-provided power control parameter to manually reduce the power consumption of the backlight units. Some techniques employ a DNN-based pixel compensation method, while using a traditional BLE algorithm, as well as techniques that use two separate DNNs for pixel compensation and BLE, respectively.

Therefore, there is a need for an improved approach to further improve the backlight extraction whereby the displayed image quality is better maintained while the power consumption of the backlight units are reduced, as well as reducing the computational complexity and/or otherwise improving efficiency of the backlight extraction and control.

### SUMMARY

According to one aspect of the disclosure, there is provided a method of controlling backlights for a local dimming display. The method includes: determining backlight extraction values for at least two local dimming region sets of a local dimming display by applying separate power regularizations for the at least two local dimming region sets; and controlling the local dimming display in accordance with the backlight extraction values in order to display image data representing an image.

According to various embodiments, the method may further include any one of the following features or any technically-feasible combination of some or all of the features:
for each local dimming region set of the at least two local dimming regions sets, one or more local dimming regions are selected to belong to the local dimming region based on projected backlight extraction values derived from the image data;
a local dimming region threshold is determined based on the projected backlight extraction values, and wherein the local dimming region threshold is determined by averaging the projected backlight extraction values;
the at least two local dimming region sets includes a first local dimming region set corresponding to one or more first local dimming regions on the local dimming display and a second local dimming region set corresponding to one or more second local dimming regions on the local dimming display;
the separate power regularizations for the at least two local dimming regions includes using a first power regularization value for the one or more first local dimming regions and a second power regularization value for the one or more second local dimming regions whereby suppression of luminance is different for the one or more first local dimming regions and the one or more second local dimming regions;
the first local dimming region set corresponds to one or more dark regions of the image and the second local dimming region set corresponds one or more bright regions of the image;
the first power regularization value and the second power regularization value are configured so that, when applied, the dark region(s) of the image are suppressed more than the bright region(s) of the image;
power control parameter data is used to control power consumption of the local dimming display when displaying the image on the local dimming display;
the power control parameter data includes a single power control parameter;
the power control parameter data includes a first power control parameter for controlling the first local dimming regions corresponding to the dark region(s) and a second power control parameter for controlling the second local dimming regions corresponding to the bright region(s);
the backlight extraction is performed using a machine learning model that is trained using a loss function that includes a first regularization term and a second regularization term;
the backlight extraction is performed using a neural network (NN) as the machine learning model that takes, as input, power control parameter data and an input image, and generates the backlight extraction values;
the neural network is trained using a loss function that includes a first regularization term and a second regularization term;
the first regularization term includes a first regularization value that is different than a second regularization value included in the second regularization term;
the NN is a deep neural network (DNN) that includes a plurality of convolutional layers for encoding the input image into an encoded feature embedding;
the encoded feature embedding is used to determine the backlight extraction values;
the encoded feature embedding is used to determine the backlight extraction values by: upsampling the encoded feature embedding and concatenating the upscaled encoded feature embedding with the input image in order to generate the backlight extraction values;
the machine learning model is trained using a training process that includes for a given input image: determining local dimming perceptual data that represents a perceived appearance of the given input image as though the given input image is being displayed on the local dimming display; and/or determining target perceptual data that represents a perceived appearance of the given input image as though the given input image is being displayed on a target display characterized by predetermined display characteristic data;
the predetermined display characteristic data includes ideal diffuser values representing an ideal diffuser for a display;
the local dimming perceptual data and the target perceptual data are each determined using a perceptual uniform (PU) encoder;
ambient luminance data is used by the PU encoder for determining the local dimming perceptual data and the target perceptual data;
a point spread function (PSF) is used to determine local dimming diffuser data, and wherein the local dimming diffuser data is input into the PU encoder as a part of determining the perceived appearance of the local dimming perceptual data;
determining the backlight extraction values includes post-processing whereby projected backlight extraction values and initial backlight extraction values are used for determining the backlight extraction values; and/or
the initial backlight extraction values are determined using a deep neural network (DNN) trained for backlight extraction.

According to another aspect of the disclosure, there is provided a non-transitory, computer-readable memory storing backlight extraction model data representing a neural network for backlight extraction of a local dimming display that is trained using a loss function that includes a first regularization term and a second regularization term, wherein the first regularization term includes a first regularization value that is different than a second regularization value included in the second regularization term.

According to yet another aspect, there is provided a local dimming display control system, comprising: at least one processor and the non-transitory, computer readable memory as recited in the previous aspect of the disclosure, wherein the at least one processor is configured to execute the neural network using the backlight extraction model data in order to determine backlight extraction values for an input image.

According to yet another aspect, there is provided a local dimming display system, comprising: a local dimming display; and the local dimming display control system as recited in the previous aspect of the disclosure, wherein the local dimming display control system is configured to control the local dimming display in accordance with the backlight extraction values.

According to yet another aspect of the disclosure, there is provided a local dimming display control system, comprising: at least one processor and non-transitory, computer readable memory storing computer instructions that, when executed by the at least one processor, cause the local dimming display control system to determine backlight extraction values for the at least two local dimming region sets by applying separate power regularizations for the at least two local dimming region sets.

According to yet another aspect of the disclosure, there is provided a method of training a backlight extraction model, comprising training a model for backlight extraction using separate power regularizations for at least two local dimming region sets of a local dimming display.

According to various embodiments, the method may further include any one of the following features or any technically-feasible combination of some or all of the features:
the separate power regularizations for the at least two local dimming region sets of the local dimming display includes a first power regularization characterized by a first power regularization term and a second power regularization characterized by a second power regularization term, wherein the first power regularization term is used for power regularization of one or more first local dimming regions belonging to a first local dimming region set of the at least two local dimming region sets, and wherein the second power regularization term used for power regularization of one or more second local dimming regions belonging to a second local dimming region set of the at least two local dimming region sets;
a loss function used for training the model includes at least two power regularization terms, each of which is characterized by a different power regularization coefficient or other value;
the at least two local dimming region sets are determined for a first image based on first projected backlight extraction values derived from image data for the first image;
the first image is a part of a plurality of training images, wherein, for each training image of the plurality of training images, a plurality of local dimming region sets are determined based on projected backlight extraction values derived from image data for the training image;
the model is a deep neural network (DNN) that includes a plurality of convolutional layers for encoding the input image into an encoded feature embedding;
the encoded feature embedding is used to determine the backlight extraction values;
the encoded feature embedding is used to determine the backlight extraction values by: upsampling the encoded feature embedding and concatenating the upscaled encoded feature embedding with the input image in order to generate the backlight extraction values;
training the model includes: for a given training image, determining local dimming perceptual data that represents a perceived appearance of the given training image as though the given training image is being displayed on the local dimming display and determining target perceptual data that represents a perceived appearance of the given training image as though the given training image is being displayed on a target display characterized by predetermined display characteristic data;
the predetermined display characteristic data includes ideal diffuser values representing an ideal diffuser;
the local dimming perceptual data and the target perceptual data are each determined using a perceptual uniform (PU) encoder;
ambient luminance data is used by the PU encoder for determining the perceived appearance of the local dimming perceptual data and the perceived appearance of the target perceptual data; and/or
a point spread function (PSF) is used to determine local dimming diffuser data, and wherein the local dimming diffuser data is input into the PU encoder as a part of determining the local dimming perceptual data.

According to yet another aspect of the disclosure, there is provided a method of controlling backlights for a local dimming display. The method includes: obtaining image data representing an image; determining at least two local dimming regions based on luminance of the image data, wherein each of the at least two local dimming regions includes a controllable backlight of a local dimming display, and wherein the controllable blacklight for a given one of the at least two local dimming regions is used for providing a controllable light output for a region of the local dimming display; determining backlight extraction values for the at least two local dimming regions by applying separate power regularizations for the at least two local dimming regions; and controlling the local dimming display in accordance with the backlight extraction values.

Various aspects disclosed herein may, as will be understood and appreciated in light of the foregoing discussion, overlap with one another and are not to be interpreted as mutually-exclusive scopes, unless clearly provided for.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram illustrating a local dimming display system having a local dimming display control system used for controlling two or more local dimming regions of the local dimming display using a backlight extraction model, according to one embodiment;

FIG. 2 is an exemplary local dimming display illustrating a two-dimensional array of local dimming regions, each of which corresponds to a controllable light output generated by light source(s) for that local backlight region;

FIG. 3 is a block diagram and flowchart illustrating a training framework used to train the backlight extraction model of FIG. 1, according to one embodiment; and

FIG. 4 is a block diagram and flowchart illustrating an exemplary deep neural network (DNN) based architecture that is used for the backlight extraction model of FIG. 1, according to one embodiment and trained using the training framework of FIG. 3, according to one embodiment.

### DETAILED DESCRIPTION

A system and method is provided for backlight extraction for a local dimming display, including a training system and method for training a model for backlight extraction (also referred to as a “backlight extraction model”), as well as determining backlight extraction values for at least two local dimming regions of the local dimming display and controlling the local dimming display in accordance with the determined backlight extraction values.

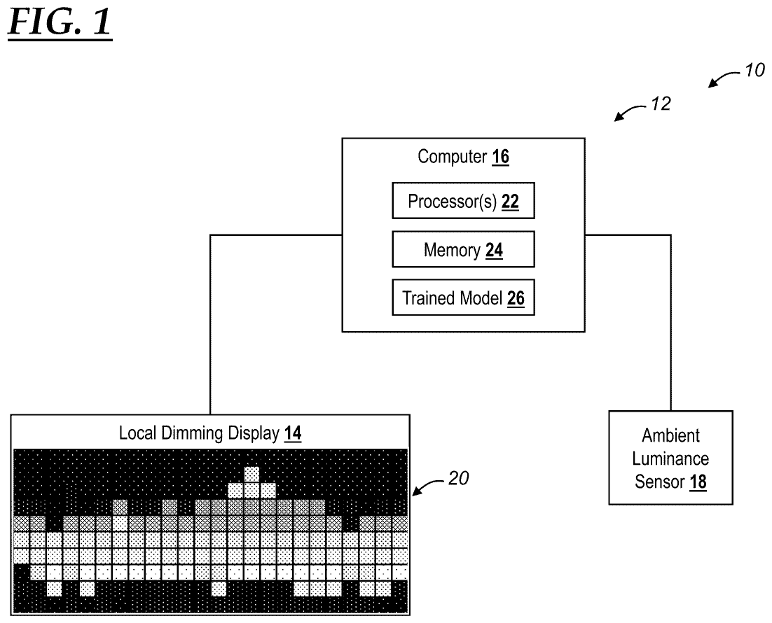

With reference to FIG. 1, there is shown a local dimming display system 10 having a local dimming display control system 12 and a local dimming display 14. The local dimming display control system 12 includes a computer 16 and an ambient luminance sensor 18. In embodiments, the ambient luminance sensor 18 may be omitted. The lines connecting the local dimming display 14 to the computer 16 and connecting the computer 16 to the ambient luminance sensor 18 are used for electronic data transmission whereby data is transmitted therebetween, in either a one- or two-way fashion, as will be appreciated and made apparent to those skilled in the art in light of the following discussion.

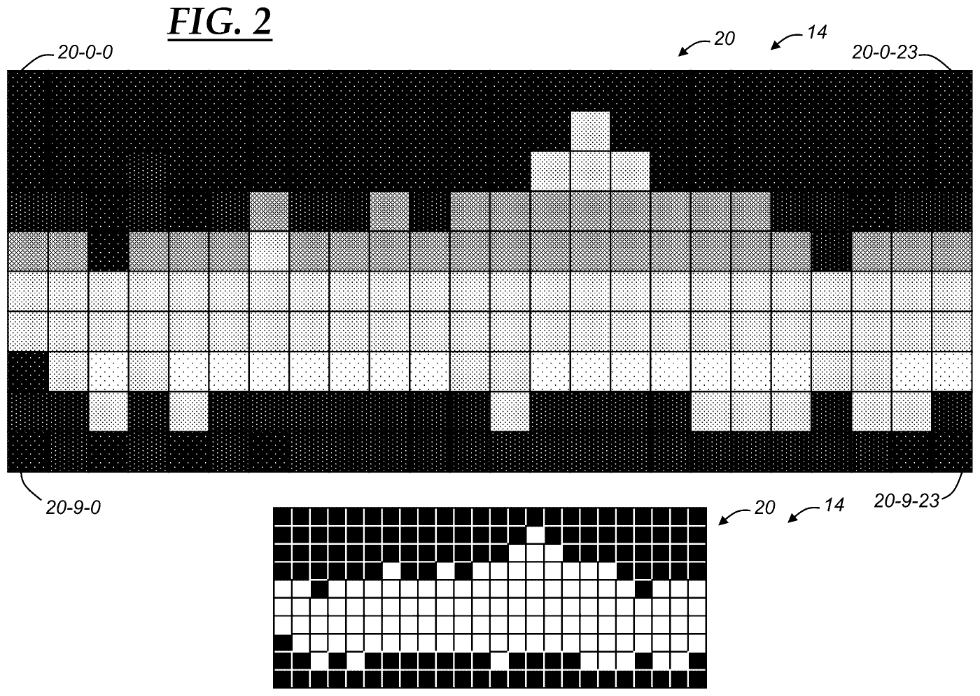

The local dimming display 14 is illustrated as having a plurality of local dimming regions 20, each of which is a zone, area, or other region of the local dimming display 14 that is able to have its backlighting independently controlled of other such local dimming, zones, areas, or regions. With reference now to FIG. 2, and with continued reference to FIG. 1, the local dimming display 14 of the illustrative embodiment includes 240 local dimming regions organized in a two-dimensional array with dimensions 10×24; that is, ten (10) rows and twenty-four (24) columns of local dimming regions 20 are shown, whereby the notation 20-i-j may be used to denote a particular local dimming region where index i indicates the row index (starting at 0 for top row and increasing by a single integer for each subsequent row index) and index j indicates the column index (starting at 0 for left column and increasing by a single integer for each subsequent column index). As examples: the top left local dimming region is referred to herein as local dimming region 20-0-0; the top right local dimming region is referred to herein as local dimming region 20-0-23; the bottom left local dimming region is referred to herein as local dimming region 20-9-0; and the bottom right local dimming region is referred to herein as local dimming region 20-9-23. Of course, according to other embodiments, the number of local dimming regions 20 varies and may even be organized or arranged in a different manner, without necessarily being a two-dimensional array of local dimming regions.

According to embodiments, the local dimming display 14 may be a liquid crystal display (LCD), including those using light emitting diodes (LEDs) as a backlight source that emits light in a controllable fashion for each local dimming region 20. Exemplary displays that may be used for the local dimming display 14 include, for example and without limitation: SAMSUNG QLED and LG NanoCell TVs (both LCDs with full-array local dimming); the SONY XBR Series LCD; the VIZIO P-Series Quantum X LCD; the ASUS ProArt PA32UCX LCD; the ACER Predator X27 LCD; and the APPLE Pro Display XDR. The local dimming display 14 is powered using electricity from a power source (not shown) and displays images that may be perceived by a user viewing the screen or display area of the local dimming display 14.

With reference back to FIG. 1, the ambient luminance sensor (or ambient light sensor (ALS)) 18 is used for determining ambient luminance data representing ambient luminance (ambient light intensity) of the local (proximate) environment where the local dimming display 14 displays images or content. In one embodiment, the ambient luminance sensor 18 is a TSL2520 or TSL2521 manufactured by AMS; however, of course, other sensors may be used as the ambient luminance sensor 18, according to embodiments. For example, in one embodiment, the local dimming display system 10 is incorporated into a passenger cabin of a vehicle (e.g., passenger car) whereby, in such an example, the local environment would refer to said passenger cabin and the ambient luminance data includes an ambient luminance value (using lux units, for example) indicating the ambient luminance of the passenger cabin. The ambient luminance sensor 18 is communicatively coupled to the computer 16 so as to send captured ambient luminance data to the computer 16 for processing, such as for use in the disclosed method.

The computer 16 is any suitable electric/electronic computing device that processes data in electronic form. The computer 16 includes at least one processor 22, non-transitory computer-readable memory (referred to herein also as simply “memory”) 24, and a trained backlight extraction model 26. Although the trained backlight extraction model (referred to herein also as simply “trained model”) 26 is shown as separate from the at least one processor 22 and the memory 24, it will be appreciated that the trained backlight extraction model 26, which is embodied by trained backlight extraction model data, is stored on the memory 24 and executed by the at least one processor 22. The trained model 26 is discussed in more detail below, including its training process and intended use whereby it performs inference for backlight extraction.

Current backlight extraction (BLE) approaches seek to regularize or otherwise control backlight extraction values together, resulting in overall suppression simultaneously. For example, the controllable backlight dimming method introduced in Duan, Lvyin, et al. “Deep Controllable Backlight Dimming.” arXiv preprint arXiv:2008.08352 (2020) uses a single power regularization term, as shown in the Equation (1) below:

$${L}_{reg} = {v}_{p} {λ}_{p} {\sum }_{( i , j )} {B}_{i , j} \qquad Equation ( 1 )$$

where vₚ∈[0,1] is a power control parameter, λₚ is the power regularization coefficient or term, and B_{i,j}∈[0,1] is the extracted backlight value (referred to also as a “backlight extraction value”) with height index i∈{0, . . . , H_{b}−1} and width index j∈{0, . . . , W_{b}−1}. The term H_{b} is the height or number of local dimming regions (or the number of rows) and the term W_{b} is the width or number of local dimming regions (or the number of columns). The regularization term in Equation (1) has an effect of suppressing the BLE values when increasing vₚ and, hence, can reduce the power consumption. However, a notable limitation of such conventional methodologies is that the above approach suppresses the overall BLE values simultaneously, resulting in darkening the bright region of the image resulting in lowering the contrast ratio (CR) of the image as displayed.

To overcome such a limitation, an enhanced power control regularization technique is introduced whereby, backlight regions are suppressed at a different rate for different sets of local dimming regions; for example, with increasing vₚ, the enhanced power control regularization technique suppresses (lowers) the BLE values corresponding to darker regions of the image more (or at least differently) than when compared to suppression of BLE values corresponding to brighter regions. To this end, backlight regions of an input image are divided into a plurality of local dimming region sets, where each local dimming region set includes is a set of one or more local dimming regions 20 of the local dimming display 14; for example, an average pre-estimated (or projected) BLE values are determined, such as where a simple traditional max-based approach is used, and then an average or mean of the BLE values is used as a local dimming region threshold that is used to determine which of the local dimming regions 20 are to be included in the first (or dark) local dimming region set and which are to be included in the second (or bright) local dimming region set. Thereafter, power regularizations are applied separately to two divided regions and using distinct and separate power regularization terms. Consequently, this approach enables maintaining the bright regions of the image with less suppression of the corresponding BLE values and, hence, better preserving the CR. In the proposed framework, the projected backlight extraction values (also referred to as pre-estimated BLE values) are used as guidance while training the model for a more stable BLE.

The overall proposed loss function is given by:

$$L = {L}_{1} ( {X}_{pu}^{t} , {\hat{X}}_{pu} ) + {λ}_{g} {L}_{1} ( {B}_{g} , B ) + {v}_{p} ( {λ}_{p}^{u} {\sum }_{( i , j ) ϵ {C}_{u}} {B}_{i , j} + {λ}_{p}^{l} {\sum }_{( i , j ) ϵ {C}_{l}} {B}_{i , j} ) \qquad Equation ( 2 )$$

where L₁ (.,.) is the L₁-norm, [symbol] is the target perceived image, \hat{X}ₚᵤ is the estimated perceived image via the backlight extraction model, B_{g} represents the pre-estimated or projected BLE values, vₚ∈[0,1] is a power control parameter, Cᵤ denotes a first local dimming region set (for the upper or brighter regions in the present embodiment), Cₗ denotes a first local dimming region set (for the lower or darker regions in the present embodiment), [symbol] is a first power regularization term that is applied to the first or upper local dimming region set, and [symbol] is a second power regularization term that is applied to the second or lower local dimming region set.

In the present embodiment, the two local dimming region sets Cᵤ, Cᵢ are determined based on an average or mean of the projected BLE values B_{g} whereby those values over the threshold (referred to as the local dimming region threshold) correspond to brighter regions and use character u to denote the “upper” local dimming regions (those above the threshold) and character l to denote the “lower” local dimming regions (those below the threshold). In embodiments, the first power regularization term [symbol] is less than the second power regularization term [symbol] (i.e., [symbol] < [symbol] ).

Furthermore, in some embodiments, a plurality of power control parameters, such as one power control parameter for each of the local dimming region sets. For example, when using two local dimming region sets, such as the first or upper local dimming region set and the second or lower local dimming region set, two power control parameters may be used: a first or upper power control parameter [symbol] ∈[0,1] and a second or lower power control parameter [symbol] ∈[0,1]. Equation (3) below provides an implementation of the loss function for such an embodiment where the first power control parameter and the second power control parameter are used:

$$L = {L}_{1} ( {X}_{pu}^{t} , {\hat{X}}_{pu} ) + {λ}_{g} {L}_{1} ( {B}_{g} , B ) + ( {v}_{p}^{u} {λ}_{p}^{u} {\sum }_{( i , j ) ϵ {C}_{u}} {B}_{i , j} + {v}_{p}^{l} {λ}_{p}^{l} {\sum }_{( i , j ) ϵ {C}_{l}} {B}_{i , j} ) \qquad Equation ( 3 )$$

In some embodiments, a user may provide an input that indicates a power control value used as or to derive the power control parameter data. The power control parameter data may include a single power control parameter vₚ such as in Equation (2); or the power control parameter data may include two or more power control parameters [symbol] , [symbol] . The power control value, such as “80%” total power or 0.8, may be converted to two power control parameters [symbol] , [symbol] using, for example, a look up table or other predetermined data that may be determined through empirical testing as appreciated by those skilled in the art. For example, such a lookup table may have two associated power control parameters (values) for each user-input power control parameter value. In other embodiments, a calculation may be used to determine such power control parameters.

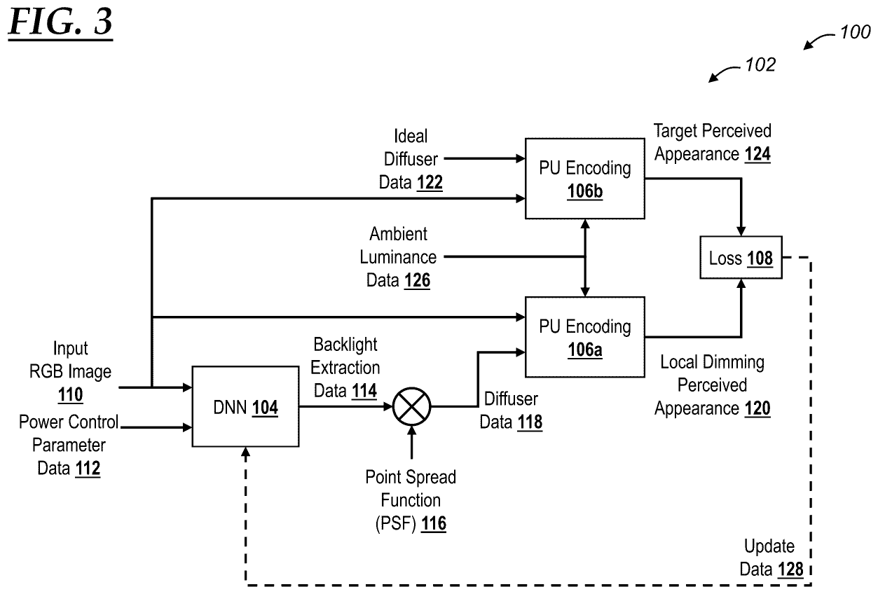

With reference to FIG. 3, there is shown a local dimming backlight extraction training framework (referring to herein also as simply “training framework”) 100 that is implemented using suitable computers and computing technology, including, for example, graphics or tensor processing units. The training framework 100 implements a local dimming backlight extraction training process (referring to herein also as simply “training process”) 102, which is used to train a model for backlight extraction so as to generate the trained backlight extraction model 26. The training framework 100 includes a deep neural network (DNN) 104 as the model for backlight extraction (referred to also as a “backlight extraction model”), and this model or DNN 104 is trained using the training process 102 so as to generate the trained backlight extraction model 26. The training framework 100 further includes a perceptual uniform (PU) encoder used for perceptual uniform encoding 106a, 106b as well as a loss function 108.

The training process 102 is performed over many, such as thousands or millions, of iterations whereby a target perceived appearance and a local dimming perceived appearance are compared through use of the loss function 108 and used to generate update data that is then used to train the DNN 104 through backpropagation. Further, although the discussion herein refers to steps or processes as being performed in a particular order, those skilled in the art will appreciate that, according to embodiments, other technically-feasible orders of operation may be used for performing iterations of the training process 102, one of which will be discussed below.

The training process 102 begins with inputting an input image (e.g., an RGB image) 110 into the DNN 104 along with power control parameter data 112. The input image 110 is one of a plurality of training images that are prepared for training the DNN 104. The power control parameter data 112 represents the power control parameter(s), which may be specified or based on a user inputted power control value. The DNN 104 then generates backlight extraction data 114 having or backlight extraction values. The backlight extraction values are then input into a point spread function (PSF) 116 in order to generate backlight diffuser data 118.

The backlight diffuser data 118 and the input image 110 are input into the perceptual uniform (PU) encoder to perform a first or local dimming PU encoding 106a, which thereby generates a local dimming perceived appearance 120. Likewise, the input image 110 and ideal or target diffuser data 122 (such as those modeled off organic light emitting diode (OLED) displays) are input into the PU encoder to perform a second or target PU encoding 106b, which thereby generates a target perceived appearance 124. Further, in at least some embodiments including the present embodiment, ambient luminance data 126 is used also as input for the PU encoding 106a, 106b in order to take into consideration ambient luminance of the environment in which the display is used.

The local dimming perceived appearance 120 and the target perceived appearance 124 are input into the loss function 108 along with power control parameter data in order to generate loss or update 128 that is then used to train the DNN 104 via backpropagation. The training process 102 then performs additional iterations, iteratively updating the weights of the DNN 104.

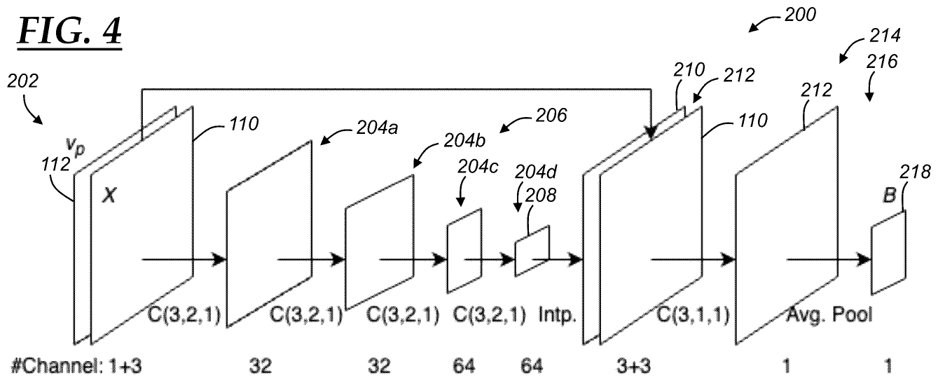

With reference to FIG. 4, there is shown a DNN architecture 200, more particularly a convolution DNN architecture 200, that may be used for the backlight extraction model or DNN 104. It will be appreciated that other DNN architectures or even other machine learning (ML) models may be used. The DNN architecture 200 shown in FIG. 4 is one that has improved efficiencies for backlight extraction due to leveraging principles of U-Nets, namely by employing a skip connection between the input image 110 and an upscaled/upsampled convolutional layer.

Accordingly, due to the DNN architecture 200, the system and method enjoy improved computational efficiencies for backlight extraction, in addition to the above enhanced power regularization. First, instead of using the U-Net based structure as in previous architectures, the DNN architecture 200 is smaller and reduces the computational complexity. As shown in FIG. 4, C(k, s, p) denotes the convolutional operation with kernel size of k, stride size of s and padding size of p. The input image 110 and the power control parameter data 112 (referred to as the input feature 202) are first propagated through the convolutional layers 204a-d in a downsampling or encoding fashion, forming encoder 206, which generates encoded feature data 208. The encoder 206 is formed as half of a U-Net. The encoded feature data 208 is then up-scaled via bi-linear interpolation to produce upscaled feature data 210 and this upscaled feature data 210 is concatenated with the given input image 110, similar to a skip connection in the U-Net architecture, to generate a concatenated feature 212 that is then propagated through the final convolutional layer 214 and average pooling layer 216. Instance normalization is then applied to all hidden layers. In the present embodiments, the rectified linear unit (ReLU) is employed as the activation function, except for the final output layer where the sigmoid function is used. Accordingly, a backlight extraction output 218 is generated, and includes or at least indicates backlight extraction values to be used for controlling the local dimming regions of the local dimming display. This DNN architecture thus reduces the computational complexity compared to using the entire U-Net (its decoder is omitted), resulting in improved efficiency. This modified CNN for BLE is referred to as a BLE-mCNN.

Further, an efficient post-processing scheme is performed for the BLE output 218, whereby final BLE values Bₐ are computed based on the weighted average of B and B_{g} with the weighting factor specified by vₚ:

$${B}_{a} = {v}_{p} B + ( 1 - {v}_{p} ) {B}_{g} \qquad Equation ( 4 )$$

In other embodiments, other post-processing or weighting techniques may be used.

Any one or more of the processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc. Any one or more of the non-transitory, computer-readable memory discussed herein may be implemented as any suitable type of memory that is capable of storing data or information in a non-volatile manner and in an electronic form so that the stored data or information is consumable by the processor. The memory may be any a variety of different electronic memory types and may be selected based on the application in which it is to be used. Examples of types of memory that may be used include including magnetic or optical disc drives, ROM (read-only memory), solid-state drives (SSDs) (including other solid-state storage such as solid state hybrid drives (SSHDs)), other types of flash memory, hard disk drives (HDDs), non-volatile random access memory (NVRAM), etc. It should be appreciated that any one or more of the computers discussed herein may include other memory, such as volatile RAM that is used by the processor, and/or multiple processors.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of controlling backlights for a local dimming display, comprising the steps of:
determining backlight extraction values for two or more local dimming region sets of a local dimming display through use of a trained machine learning model, wherein the trained machine learning model is trained using a loss function that applies separate power regularizations for at least two local dimming region sets; and
controlling the local dimming display in accordance with the backlight extraction values in order to display image data representing an image.

2. The method of claim 1, wherein, for each local dimming region set of the at least two local dimming regions sets, one or more local dimming regions are selected to belong to the local dimming region set based on projected backlight extraction values derived from image data.

3. The method of claim 2, wherein a local dimming region threshold is determined based on the projected backlight extraction values, and wherein the local dimming region threshold is determined by averaging the projected backlight extraction values.

4. The method of claim 1, wherein the at least two local dimming region sets includes a first local dimming region set corresponding to one or more first local dimming regions on the local dimming display and a second local dimming region set corresponding to one or more second local dimming regions on the local dimming display, wherein the separate power regularizations for the at least two local dimming regions includes using a first power regularization value for the one or more first local dimming regions and a second power regularization value for the one or more second local dimming regions, whereby suppression of luminance is different for the one or more first local dimming regions and the one or more second local dimming regions.

5. The method of claim 4, wherein the first local dimming region set corresponds to one or more dark regions of a given image and the second local dimming region set corresponds to one or more bright regions of the given image, and wherein the first power regularization value and the second power regularization value are configured so that, when applied, the dark region(s) of the given image are suppressed more than the bright region(s) of the given image.

6. The method of claim 5, wherein power control parameter data is used to control power consumption of the local dimming display when displaying the given image on the local dimming display.

7. The method of claim 6, wherein the power control parameter data includes a single power control parameter.

8. The method of claim 1, wherein the separate power regularizations of the loss function include a first regularization term and a second regularization term.

9. The method of claim 8, wherein the first regularization term includes a first regularization value that is different than a second regularization value included in the second regularization term.

10. The method of claim 8, wherein the machine learning model is trained using a training process that includes, for a given input image:
determining local dimming perceptual data that represents a perceived appearance of the given input image as though the given input image is being displayed on the local dimming display.

11. The method of claim 10, wherein the training process further includes, for the given input image:
determining target perceptual data that represents a perceived appearance of the given input image as though the given input image is being displayed on a target display characterized by predetermined display characteristic data.

12. The method of claim 11, wherein the predetermined display characteristic data includes ideal diffuser values representing an ideal diffuser for a display.

13. The method of claim 12, wherein the local dimming perceptual data and the target perceptual data are each determined using a perceptual uniform (PU) encoder.

14. The method of claim 13, wherein ambient luminance data is used by the PU encoder for determining the local dimming perceptual data and the target perceptual data.

15. The method of claim 13, wherein a point spread function (PSF) is used to determine local dimming diffuser data, and wherein the local dimming diffuser data is input into the PU encoder as a part of determining the perceived appearance of the local dimming perceptual data.

16. The method of claim 1, wherein determining the backlight extraction values includes post-processing, and wherein projected backlight extraction values and initial backlight extraction values are used for determining the backlight extraction values.

17. The method of claim 16, wherein the initial backlight extraction values are determined using a deep neural network (DNN) trained for backlight extraction.

18. A non-transitory, computer-readable memory storing backlight extraction model data representing a neural network for backlight extraction of a local dimming display that is trained using a loss function that includes a first regularization term and a second regularization term, wherein the first regularization term includes a first regularization value that is different than a second regularization value included in the second regularization term.

19. A local dimming display control system, comprising: at least one processor and the non-transitory, computer readable memory of claim 18, wherein the at least one processor is configured to execute the neural network using the backlight extraction model data in order to determine backlight extraction values for an input image.

20. A local dimming display control system, comprising: at least one processor and non-transitory, computer readable memory storing computer instructions that, when executed by the at least one processor, cause the local dimming display control system to determine backlight extraction values for two or more local dimming region sets through use of a trained machine learning model, wherein the trained machine learning model is trained using a loss function that applies separate power regularizations for at least two local dimming region sets.
